(19) United States
(12) Patent Application Publication
(10) Pub. No.: US 2013/0198250 A1
(43) Pub. Date: Aug. 1, 2013

(54) FILE SYSTEM AND METHOD FOR CONTROLLING FILE SYSTEM

(71) Applicant: Fujitsu Limited, Kawasaki-shi (JP)

(72) Inventors: Noboru Iwamatsu, Kawasaki (JP); Naoki Nishiguchi, Kawasaki (JP)

(73) Assignee: FUJITSU LIMITED, Kawasaki-shi (JP)

(21) Appl. No.: 13/675,407

(22) Filed: Nov. 13, 2012

(30) Foreign Application Priority Data
Jan. 30, 2012 (JP) 2012-017055

(51) Int. Cl. G06F 17/30

(52) U.S. Cl. CPC G06F 17/30194
USPC 707/827

(57) ABSTRACT

A file system includes a plurality of storage devices to store therein data transmitted from a first node, a plurality of second nodes connected to the first node through a first network, a second network, and a third node. The second network connects each of the plurality of second nodes with at least one of the plurality of storage devices. The second network is different from the first network. The third node manages a location of data, and notifies, in response to an inquiry from the first node, the first node of a location of data specified by the first node. Each of the plurality of second nodes writes, through the second network, same data into a predetermined number of storage devices from among the plurality of storage devices in response to an instruction from the first node.

### CROSS-REFERENCE TO RELATED APPLICATION

This application is based upon and claims the benefit of priority of the prior Japanese Patent Application No. 2012-017055, filed on Jan. 30, 2012, the entire contents of which are incorporated herein by reference.

### FIELD

The embodiments discussed herein are related to a file system.

### BACKGROUND

A distributed file system has been known that distributes and arranges data in a plurality of computer nodes. By distributing and arranging data, the distributed file system realizes load distribution, capacity enlargement, a wider bandwidth, and the like.

A storage subsystem has been known that connects a plurality of disk controllers and a plurality of disk drive devices using a network or a switch. The storage subsystem includes a mechanism that switches a volume managed between disk controllers on the basis of the load of disk controllers, a mechanism that changes an access path from a host to a disk controller in response to the switch of the volume, and a mechanism that converts a correspondence between a volume number and an access path.

Japanese Laid-open Patent Publication No. 11-296313 discloses a related technique.

FIG. 1 is a diagram illustrating write processing in a distributed file system 100.

The distributed file system 100 includes a name node 110 and a plurality of data nodes 120-0, 120-1, . . . , and 120-n. The name node 110 and the plurality of data nodes 120-0, 120-1, . . . , and 120-n are connected to one another through a network 150. The “n” is a natural number. Hereinafter, one arbitrary data node from among the data nodes 120-0, 120-1, . . . and 120-n is referred to as a “data node 120”. More than one arbitrary data nodes from among the data nodes 120-0, 120-1, . . . , and 120-n are referred to as “data nodes 120”.

The name node 110 manages a correspondence between a data block and a data node 120 storing therein the data block. The data node 120 storing therein the data block means a data node 120 including a hard disk drive (HDD) storing therein the data block.

For example, when a client node 130 connected to the distributed file system 100 through the network 150 performs writing on the distributed file system 100, the client node 130 sends an inquiry to the name node 110 about a data node 120 into which a data block is to be written. In response, the name node 110 selects a plurality of data nodes 120 into which a data block is to be written and notifies the client node 130 of the plurality of data nodes 120.

The client node 130 instructs one of the data nodes 120 specified by the name node 110, for example, the data node 120-0, to write therein the data block. In response, the data node 120-0 writes the data block into an HDD of the data node 120-0. The data node 120-0 instructs the other data nodes 120 specified by the client node 130, for example, the data node 120-1 and the data node 120-n to write therein the same data block as the data block written into the data node 120-0. In this way, replicas of the data block written into the data node 120-0 are created in the data node 120-1 and data node 120-n.

When a replica is created, data communication turns out to be performed between the data nodes 120 through the network 150 as many times as the replica is created. In this case, since a network bandwidth is used for creating the replica, the speed of writing a data block from the client node 130 into the distributed file system 100 is decreased.

When data blocks stored in data nodes 120 are biased, or withdrawal of a data node 120 or addition of a data node 120 occurs, the distributed file system 100 performs rearrangement of data blocks. The rearrangement of data blocks is referred to as “rebalancing processing”.

When the rebalancing processing is performed, data block relocation between the data nodes 120 is performed as illustrated in FIG. 2. FIG. 2 exemplifies a case where data is relocated from the data node 120-0 to the data node 120-n through the network 150.

In the same way as the write processing of a data block described in FIG. 1, since a network bandwidth is used for relocating data blocks between the data nodes 120, the speed of writing a data block from the client node 130 into the distributed file system 100 is decreased.

When a data node 120 crashes, the distributed file system 100 performs fail-over processing. In the fail-over processing, the distributed file system 100 re-creates, in another data node 120, a replica of a data block stored in the crashed data node 120. FIG. 3 illustrates a case where a replica of a data block stored in the crashed data node 120-0 is re-created by copying the replica stored in the data node 120-1 to other data node 120-n through the network 150.

Also in this case, in the same way as the write processing of a data block described in FIG. 1, since a network bandwidth is used for copying the replica in the re-creation processing, the speed of writing a data block from the client node 130 into the distributed file system 100 is decreased.

### SUMMARY

According to an aspect of the present invention, provided is a file system including a plurality of storage devices to store therein data transmitted from a first node, a plurality of second nodes connected to the first node through a first network, a second network, and a third node. The second network connects each of the plurality of second nodes with at least one of the plurality of storage devices. The second network is different from the first network. The third node manages a location of data, and notifies, in response to an inquiry from the first node, the first node of a location of data specified by the first node. Each of the plurality of second nodes writes, through the second network, same data into a predetermined number of storage devices from among the plurality of storage devices in response to an instruction from the first node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating write processing in a distributed file system;

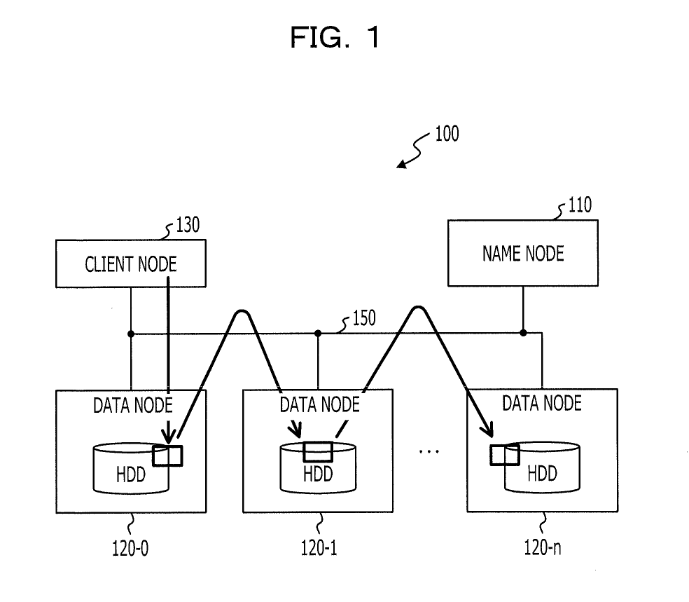

FIG. 2 is a diagram illustrating data relocation processing in a distributed file system;

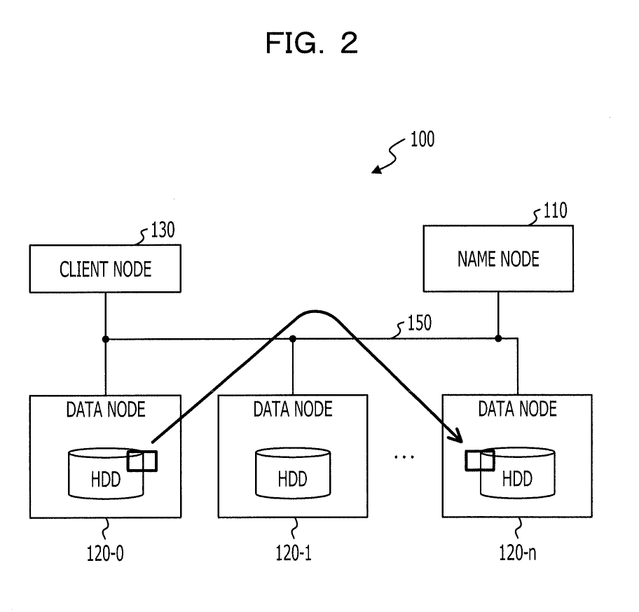

FIG. 3 is a diagram illustrating fail-over processing in a distributed file system;

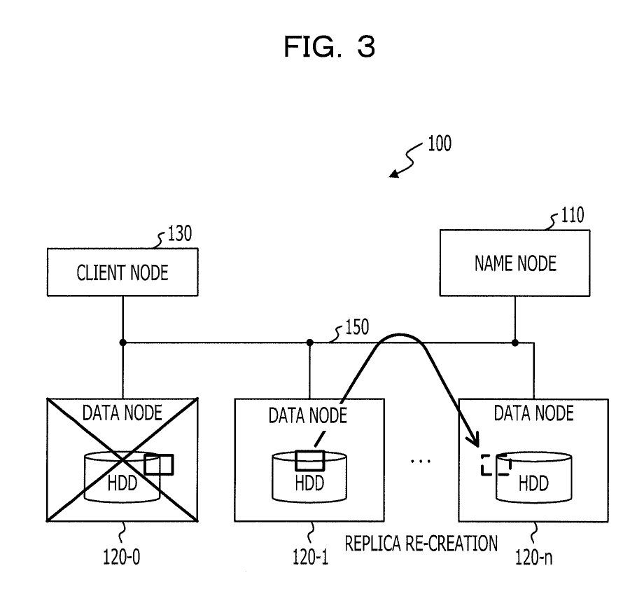

FIG. 4 is a diagram illustrating an example of a configuration of a file system;

FIG. 5 is a diagram illustrating an example of a configuration of a distributed file system;

FIG. 6 is a diagram illustrating an example of a DAS network;

FIG. 7 is a diagram illustrating an example of device management information;

FIG. 8 is a diagram illustrating an example of a zone permission table;

FIG. 9 is a diagram illustrating an example of management information used by a name node;

FIG. 10 is a diagram illustrating an example of a distributed file system;

FIG. 11 is a diagram illustrating operations of a distributed file system in data block write processing;

FIG. 12 is a flowchart illustrating an operation flow of a distributed file system when writing a data block;

FIG. 13 is a diagram illustrating operations of a distributed file system in data block read processing;

FIG. 14 is a flowchart illustrating an operation flow of a distributed file system when reading a data block;

FIG. 15 is a diagram illustrating withdrawal processing for a data node;

FIG. 16 is a flowchart illustrating an operation flow of withdrawal processing in a distributed file system;

FIG. 17 is a flowchart illustrating an operation flow of rebalancing processing in a distributed file system;

FIG. 18 is a diagram illustrating an example of a configuration of a distributed file system;

FIG. 19 is a diagram illustrating a connection relationship between a main management HDD and a sub management HDD;

FIG. 20 is a diagram illustrating an example of data block management information:

FIG. 21 is a diagram illustrating an example of data block management information;

FIG. 22 is a diagram illustrating an example of HDD connection management information;

FIG. 23 is a flowchart illustrating an operation flow of a distributed file system when writing a data block;

FIG. 24 is a flowchart illustrating an operation flow of a distributed file system when reading a data block;

FIG. 25 is a flowchart illustrating an operation flow of withdrawal processing in a distributed file system;

FIG. 26 is a flowchart illustrating an operation flow of rebalancing processing in a distributed file system; and

FIG. 27 is a diagram illustrating an example of a configuration of a name node.

### DESCRIPTION OF EMBODIMENTS

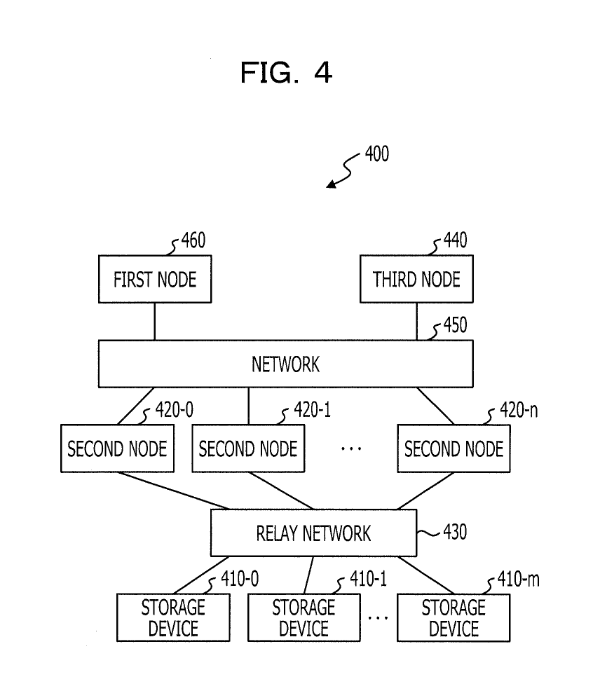

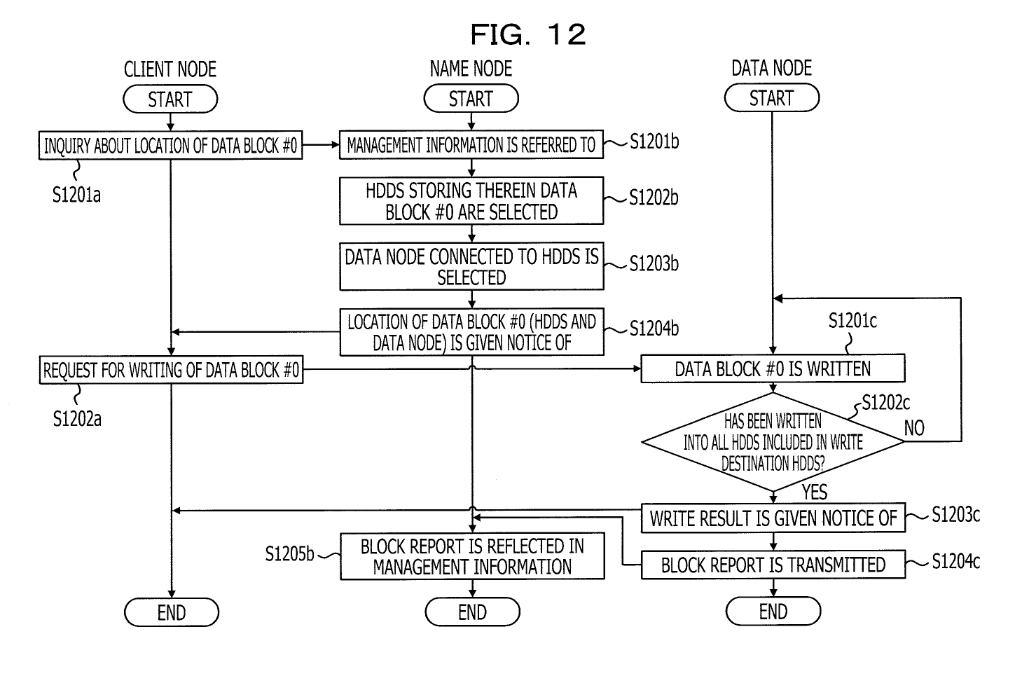

Hereinafter, examples of embodiments will be described with reference to FIG. 4 to FIG. 27. The embodiments described below are just exemplifications, and there is no intention that various modifications or applications of the embodiments, not illustrated below, are excluded. In other words, the embodiments may be implemented with various modifications such as combinations of individual embodiments insofar as they are within the scope thereof. In addition, processing procedures illustrated in a flowchart form in FIGS. 12, 14, 16, 17, and 23 to 26 do not have an effect of limiting the order of the processing. Accordingly, it should be understood that the order of the processing may be shuffled as long as the result of the processing does not change.

### First Embodiment

FIG. 4 is a diagram illustrating an example of a configuration of a file system 400 according to a first embodiment.

The file system 400 includes storage devices 410-0, 410-1, . . . , and 410-m, second nodes 420-0, 420-1, . . . , and 420-n, a relay network 430, and a third node 440. The “n” and “m” are natural numbers.

The second nodes 420-0, 420-1, . . . , and 420-n and the third node 440 are communicably connected with one another through a network 450 such as the Internet, a local area network (LAN), or a wide area network (WAN).

Hereinafter, one arbitrary storage device from among the storage devices 410-0, 410-1, . . . , and 410-m is referred to as a “storage device 410”. More than one arbitrary storage devices from among the storage devices 410-0, 410-1, . . . , and 410-m are referred to as “storage devices 410”. In addition, one arbitrary second node from among the second nodes 420-0, 420-1, . . . , and 420-n is referred to as a “second node 420”. More than one arbitrary second nodes from among the second nodes 420-0, 420-1, . . . , and 420-n are referred to as a “second nodes 420”.

The storage device 410 is a device storing therein data. As the storage device 410, for example, an HDD or the like may be used.

The second node 420 is a device performing writing of same data on a predetermined number of storage devices 410 in response to an instruction from an arbitrary first node 460 connected to the second node 420 through the network 450. Through the relay network 430, the second node 420 performs writing of same data on a predetermined number of the storage devices 410.

The relay network 430 connects each second node 420 with one or more storage devices 410. As the relay network 430, for example, one or more Serial Attached SCSI (SAS) expanders or the like may be used.

The third node 440 is a device managing a location of data stored in the file system 400. In response to an inquiry from the first node 460, the third node 440 notifies the first node 460 of a location of data specified by the first node 460. The location of data managed by the third node 440 may include, for example, a storage device 410 storing therein the data, a second node 420 connected to the storage device 410 storing therein the data through the relay network 430, or the like.

In the above-mentioned configuration, for example, upon receiving an inquiry about a write destination of specified data from the first node 460, the third node 440 notifies the first node 460 of a location of the write destination of the specified data. In response, on the basis of the location of the write destination of the specified data, given notice of by the third node 440, the first node 460 instructs the second node 420 to write the data.

In response, in accordance with the instruction to write the data, received from the first node 460, the second node 420 writes the data into a predetermined number of storage devices 410. In this case, writing the data into the storage devices 410, performed by the second nodes 420, is performed through the relay network 430 without using the network 450. Therefore, the traffic of the network 450 at the time of writing data into the file system 400 may be kept low. As a result, the speed of writing data into the file system 400 may be enhanced.

### Second Embodiment

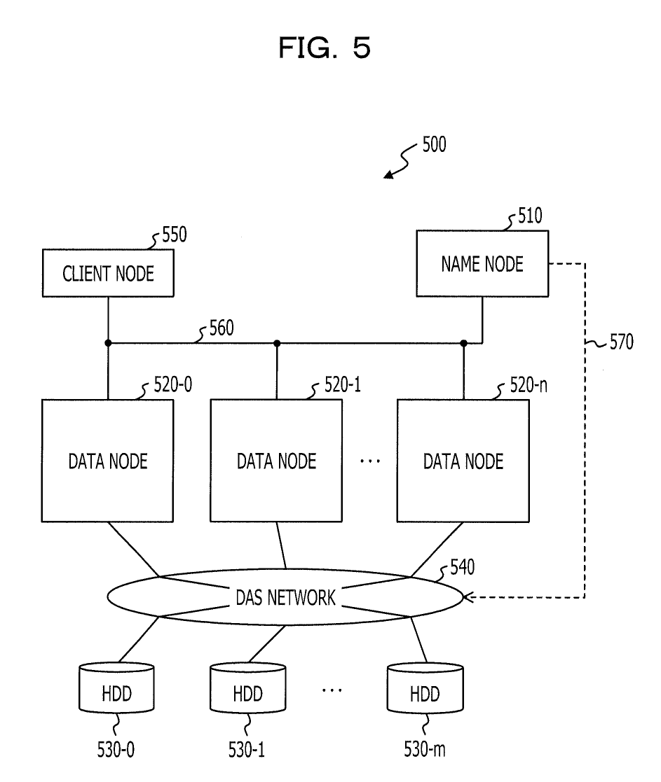

FIG. 5 is a diagram illustrating an example of a configuration of a distributed file system 500 according to a second embodiment.

The distributed file system 500 includes a name node 510, a plurality of data nodes 520-0, 520-1, . . . , and 520-n, a direct-attached storage (DAS) network 540, and a plurality of HDDs 530-0, 530-1, . . . , and 530-m.

Hereinafter, one arbitrary data node from among the data nodes 520-0, 520-1, . . . , and 520-n is referred to as a “data node 520”. More than one arbitrary data nodes from among the data nodes 520-0, 520-1, . . . , and 520-n are referred to as “data nodes 520”. In addition, one arbitrary HDD from among the HDDs 530-0, 530-1, . . . , and 530-m is referred to as an “HDD 530”. More than one arbitrary HDDs from among the HDDs 530-0, 530-1, . . . , and 530-m are referred to as “HDDs 530”.

The name node 510 and the plurality of data nodes 520-0, 520-1, . . . , and 520-n are communicably connected through a network 560 such as the Internet, a LAN, or a WAN. In addition, the plurality of data nodes 520-0, 520-1, . . . , and 520-n and the plurality of HDDs 530-0, 530-1, . . . , and 530-m are communicably connected through the DAS network 540.

The name node 510 manages a correspondence relationship between a data block and an HDD 530 storing therein the data block. In addition, the name node 510 manages a connection state between a data node 520 and an HDD 530. In addition, if desired, by operating the DAS network 540, the name node 510 changes a connection state between a data node 520 and an HDD 530. The name node 510 and the DAS network 540 may be communicably connected through a connecting wire 570 such as an Ethernet (registered trademark) cable or RS-232C cable.

In response to an inquiry from a client node 550, the name node 510 selects a plurality of HDDs 530 into which a data block is to be written. The name node 510 notifies the client node 550 of the selected HDDs 530 and data nodes 520 connected to the selected HDDs 530.

In response to an inquiry from the client node 550, the name node 510 selects HDDs 530 storing therein a data block and data nodes 520 connected to the HDDs 530, and notifies the client node 550 of the HDDs 530 and the data nodes 520.

The name node 510 may perform rebalancing processing in response to a predetermined operation of a user. In the rebalancing processing, the name node 510 selects one data node 520 from among data nodes 520 connected to both an HDD 530 storing therein a data block to be relocated and an HDD 530 serving as a relocation destination of the data block to be relocated, for example. The name node 510 instructs the selected data node 520 to relocate the data block to be relocated. In response, the data block relocation through the DAS network 540 is performed between the HDDs 530.

In response to a predetermined operation of the user, the name node 510 performs withdrawal processing for a data node 520. In the withdrawal processing, for example, when the number of data nodes 520 connected to an HDD 530 connected to the data node 520 to be withdrawn is less than a predetermined number, the name node 510 connects another data node 520 to the HDD 530 connected to the withdrawn data node 520.

Each of the data nodes 520-0, 520-1, . . . , and 520-n is connected to one or more HDDs 530 from among the HDDs 530-0, 530-1, . . . , and 530-m through the DAS network 540.

In accordance with an instruction from the client node 550, the data node 520 performs writing or reading of a data block on an HDD 530 connected through the DAS network 540.

In addition, in accordance with an instruction from the name node 510, the data node 520 performs the data block relocation between HDDs 530 through the DAS network 540 or through the network 560.

For example, when the data block relocation is performed between HDDs 530 connected to a data node 520 through the DAS network 540, the data node 520 performs the data block relocation between the HDDs 530 using the DAS network 540.

The DAS network 540 may be realized using one or more SAS expanders, for example.

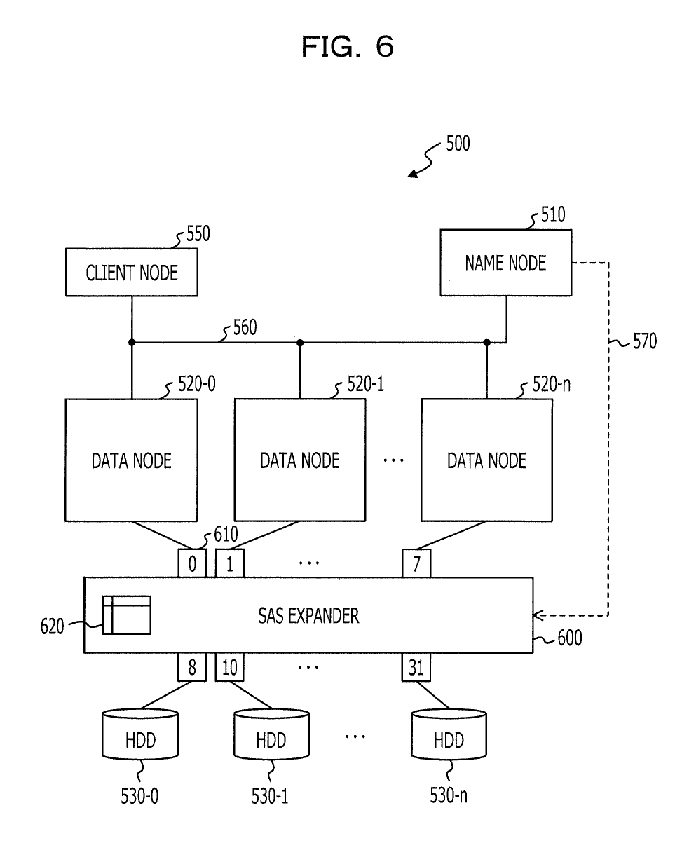

FIG. 6 is a diagram illustrating an example of the DAS network 540. In FIG. 6, an SAS expander 600 is used as the DAS network 540.

The SAS expander 600 includes a plurality of ports 610 and a storage unit 620.

FIG. 6 exemplifies an SAS expander 600 including 32 ports with port numbers “0” to “31”. A data node 520 or an HDD 530 is connected to each port 610.

A zone group identifier (ID) identifying a zone group may be assigned to each port 610. Port connections between zone groups may be defined using the zone group ID.

The zone group ID may be defined using device management information. In addition, a port connection between zone groups may be defined using a zone permission table. The device management information and the zone permission table may be stored in the storage unit 620. The SAS expander 600 establishes a connection between ports 610 in accordance with the zone permission table. By changing the zone permission table, the name node 510 may change a connection relationship between the ports 610.

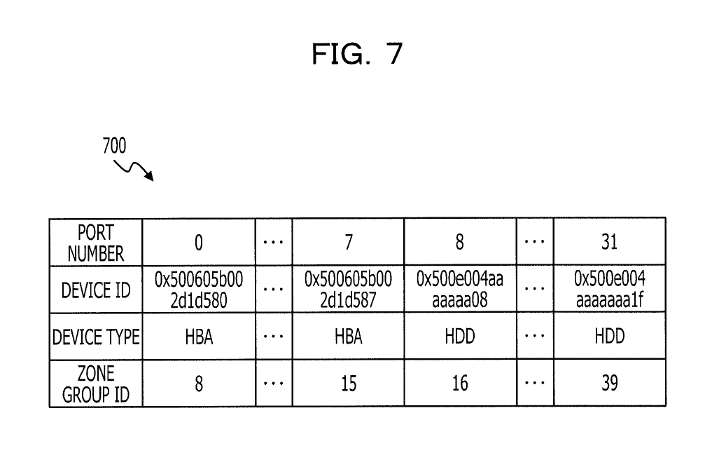

FIG. 7 is a diagram illustrating an example of device management information 700.

The device management information 700 includes a port number identifying a port 610 and a zone group ID assigned to the port 610. In addition, the device management information 700 may include, for each port 610, a device ID identifying a device connected to a port 610 and a device type indicating a type of the device connected to the port 610. The device type may indicate an HDD, a host bus adapter (HBA), and the like.

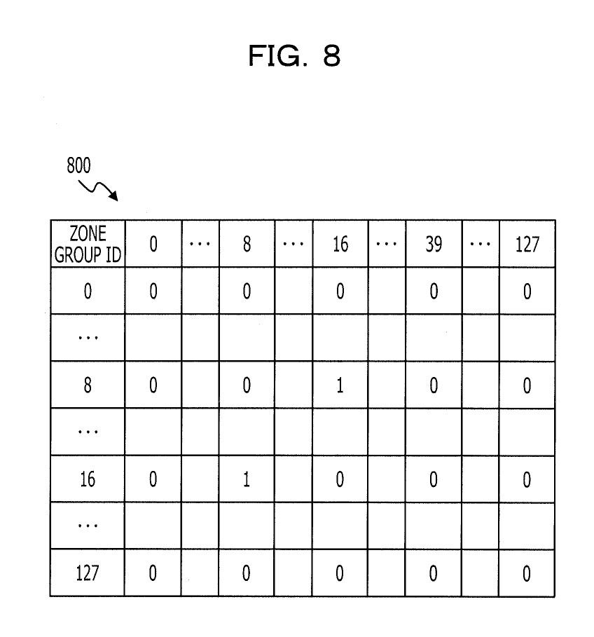

FIG. 8 is a diagram illustrating an example of a zone permission table 800.

The zone permission table 800 includes a zone group ID of a connection source and a zone group ID of a connection destination. “0” specified in the zone permission table 800 indicates that a connection is not permitted. “1” specified in the zone permission table 800 indicates that a connection is permitted.

FIG. 8 exemplifies the zone permission table 800 having a setting in which a port 610 of a zone group ID “8” and a port 610 of a zone group ID “16” are connected to each other. While FIG. 8 exemplifies a case where “0” to “127” are used as the zone group IDs, the case does not have an effect of limiting the zone groups IDs to “0” to “127”.

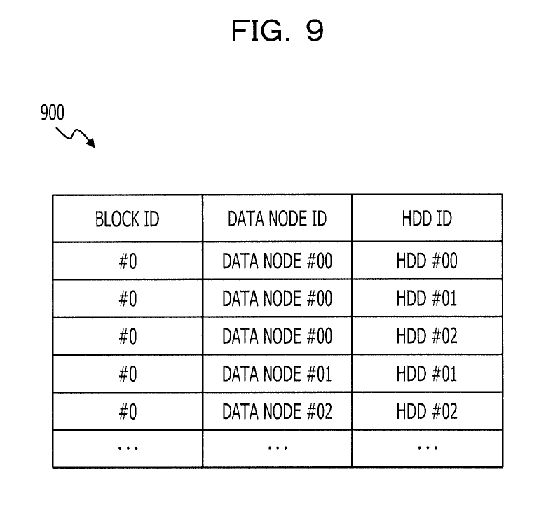

FIG. 9 is a diagram illustrating an example of management information 900 used by the name node 510.

The management information 900 may include a block ID identifying a data block and a data node ID identifying a data node 520 connected to an HDD 530 storing therein the data block identified by the block ID. Furthermore, the management information 900 may include an HDD ID identifying the HDD 530 storing therein the data block identified by the block ID.

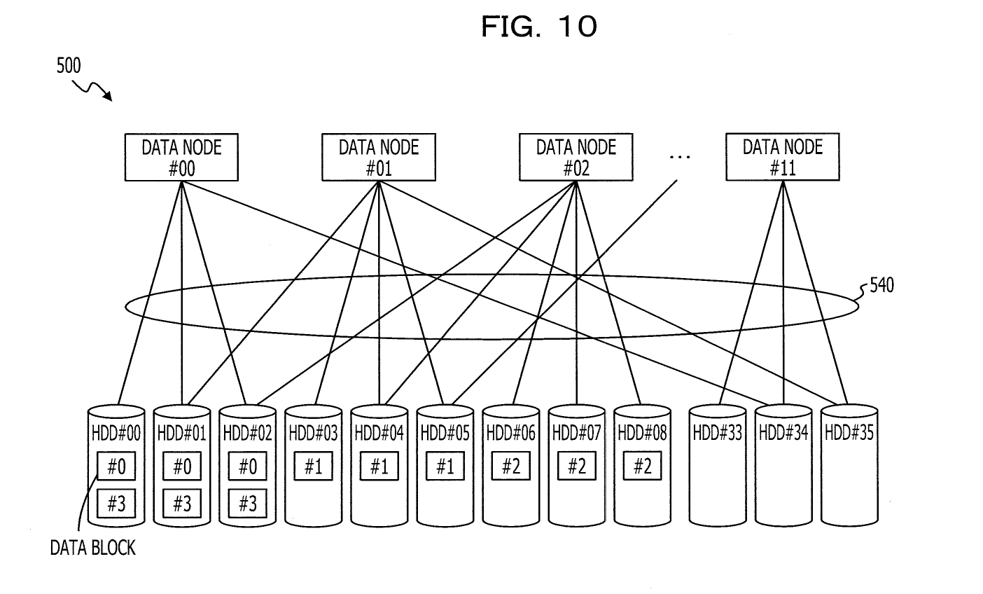

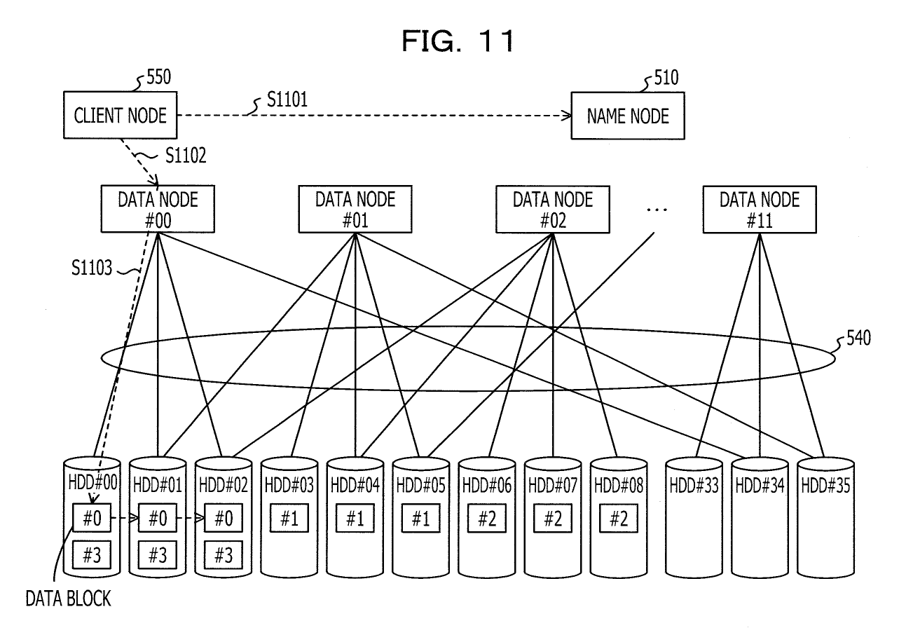

The management information 900 illustrated in FIG. 9 is a portion of the management information for the distributed file system 500 illustrated in FIG. 10. The distributed file system 500 illustrated in FIG. 10 corresponds to an example of a case where the distributed file system 500 includes 12 data nodes with data node IDs #00 to #11 and 36 HDDs with HDD IDs #00 to #35. Data blocks with block IDs #0 to #3 are stored in the HDD #00 to HDD #08. While portions of the configuration other than the portions desirable for explanation are omitted, it does not have an effect of limiting the configuration of the distributed file system 500. In addition, while, for ease of explanation, the distributed file system 500 is illustrated in a case where the data nodes #00 to #11 are used as the data nodes 520 and the HDDs #00 to #35 are used as the HDDs 530, the case does not have an effect of limiting the number of data nodes and the number of HDDs to the numbers illustrated in FIG. 10. The same applies to FIGS. 11, 13, and 15.

When referring to FIG. 10, a data block with a block ID #0 is stored in the HDDs #00, #01, and #02, for example. In addition, the HDD #00 is connected to the data node #00, the HDD #01 is connected to the data nodes #00 and #01, and the HDD #02 is connected to the data nodes #00 and #02. These relationships are registered in the management information 900 illustrated in FIG. 9.

FIG. 11 is a diagram illustrating operations of the distributed file system 500 in data block write processing.

The client node 550 divides a file into a plurality of data blocks and writes the file into the distributed file system 500.

Hereinafter, a case will be described where the client node 550 writes the data block #0 into the distributed file system 500. However, the case does not have an effect of limiting the processing illustrated in FIG. 11 to the processing performed on the data block #0.

(S1101) The client node 550 sends an inquiry, to the name node 510, about a location of the data block #0. In response, the name node 510 acquires, from the management information 900, HDD IDs of HDDs 530 storing therein the data block #0 about which the inquiry has been sent and data node IDs of data nodes 520 connected to the HDDs 530, and notifies the client node 550 of the HDD IDs and the data node IDs.

In the example of FIG. 11, as the location of the data block #0, the name node 510 notifies the client node 550 of HDD IDs #00 to #02 of the HDDs storing therein the data block #0. In addition, as the location of the data block #0, the name node 510 notifies the client node 550 of the data node ID #00 of the data node connected to the HDD #00, the data node IDs #00 and #01 of the data nodes connected to the HDD #01, and the data node IDs #00 and #02 of the data nodes connected to the HDD #02.

(S1102) Upon receiving a response to the inquiry about the location of the data block #0, the client node 550 requests the data node #00, connected to the HDDs #00 to #02 storing therein the data block #0, to perform writing of the data block #0. Along with the request, the client node 550 gives notice of a list of HDD IDs of HDDs 530 into which the data block #0 is to be written, namely, a list of the HDD IDs #00 to #02 in the example of FIG. 11.

(S1103) Upon receiving, from the client node 550, the request for writing the data block #0, the data node #00 writes the data block #0 into the HDDs 530 specified by the client node 550. In the example of FIG. 11, the data node #00 writes the data block #0 into the HDD #00. Furthermore, the data node #00 also writes the replicas of the data block #0 into the HDDs #01 and #02 through the DAS network 540.

FIG. 12 is a flowchart illustrating an operation flow of the distributed file system 500 when writing a data block.

The client node 550 divides a file, which is to be written into the distributed file system 500, into data blocks each of which has a predetermined size. The client node 550 starts write processing for the distributed file system 500. In FIG. 12, processing will be described that is performed when the data block #0 is written into the distributed file system 500. However, the case does not have an effect of limiting the processing illustrated in FIG. 12 to the processing for the data block #0.

The client node 550 sends an inquiry to the name node 510 about a location of the data block #0 (S1201a).

Upon receiving the inquiry from the client node 550, the name node 510 refers to the management information 900 (S1201b). The name node 510 selects all HDDs 530 storing therein the data block #0, on the basis of the management information 900 (S1202b). The name node 510 selects a data node 520 connected to all the HDDs 530 selected in S1202b, on the basis of the management information 900 (S1203b). When there is no data node 520 connected to all the selected HDDs 530, the name node 510 connects all the selected HDDs 530 to a same data node 520 by operating the zone permission table 800 for the DAS network 540 to select the same data node 520.

When the data block #0 about which the inquiry has been sent from the client node 550 is not registered in the management information 900, the name node 510 selects arbitrary HDDs 530 whose number corresponds to the number of preliminarily set replicas+1. The name node 510 selects a data node 520 connected to all the selected HDDs 530. The name node 510 registers the selected HDDs 530 and the data node 520 in the management information 900 in association with the data block #0.

When having selected the HDDs 530 and the data node 520, the name node 510 notifies the client node 550 of the location of the data block #0 (S1204b). The notification of the location includes the HDD IDs of one or more HDDs 530 selected in S1202b and the data node ID of the data node 520 selected in S1203b.

Upon receiving, from the name node 510, the notification of the location of the data block #0, the client node 550 requests the data node 520, specified in the notification of the location of the data block #0, to perform writing of the data block #0 (S1202a). At this time, along with the request for writing the data block #0, the client node 550 transmits a list of HDD IDs included in the notification of the location of the data block #0, as the write destination of the data block #0. Hereinafter, this list is referred to as a “write destination HDD list”.

Upon receiving the request for writing, the data node 520 writes the data block #0 on all the HDDs 530 specified in the write destination HDD list received from the client node 550 (S1201c). Processing for writing the data block #0 into an HDD 530 other than a specific HDD 530 specified in the write destination HDD list is referred to as replica creation processing.

Upon completion of writing of the data block #0 with respect to all HDDs 530 specified in the write destination HDD list (S1202c: YES), the data node 520 notifies the client node 550 of a result of the write processing (S1203c). The result of write processing may include information such as, for example, whether or not the write processing has been normally terminated, HDDs 530 where writing has been completed, and HDDs 530 having failed in writing.

The data node 520 notifies the name node 510 of a data block stored in HDDs 530 connected to the data node 520 (S1204c). This notification is referred to as a “block report”. The notification of the block report may be performed at given intervals independently of the write processing in S1201c to S1203c. Upon receiving the block report, the name node 510 reflects the content of the received block report in the management information 900 (S1205b).

When the above-mentioned processing has been completed, the distributed file system 500 terminates the write processing.

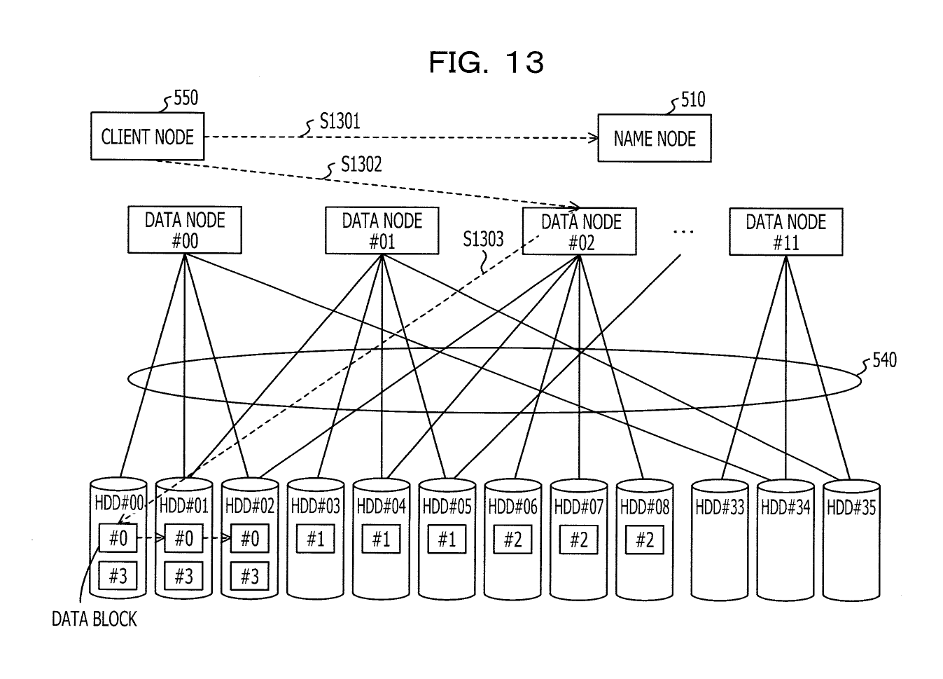

FIG. 13 is a diagram illustrating operations of the distributed file system 500 in data block read processing. Hereinafter, a case will be described where the client node 550 reads the data block #0. However, the case does not have an effect of limiting the processing illustrated in FIG. 13 to the processing for the data block #0.

(S1301) The client node 550 sends an inquiry, to the name node 510, about a location of the data block #0 to be read. In response, the name node 510 acquires, from the management information 900, HDD IDs of HDDs 530 storing therein the data block #0 about which the inquiry has been sent and data node IDs of data nodes 520 connected to the HDDs 530, and notifies the client node 550 of the HDD IDs and the data node IDs.

(S1302) Upon receiving a response to the inquiry about the location of the data block #0, the client node 550 requests a data node 520, connected to one of the HDDs #00 to #02 storing therein the data block #0, to perform reading of the data block #0. FIG. 13 exemplifies a case where the data node #02 connected to the HDD #02 storing therein the data block #0 is requested to read the data block #0.

(S1303) Upon receiving, from the client node 550, the read request for the data block #0, the data node #02 reads the data block #0 from the HDD #02 connected through the DAS network 540 and notifies the client node 550 of the data block #0.

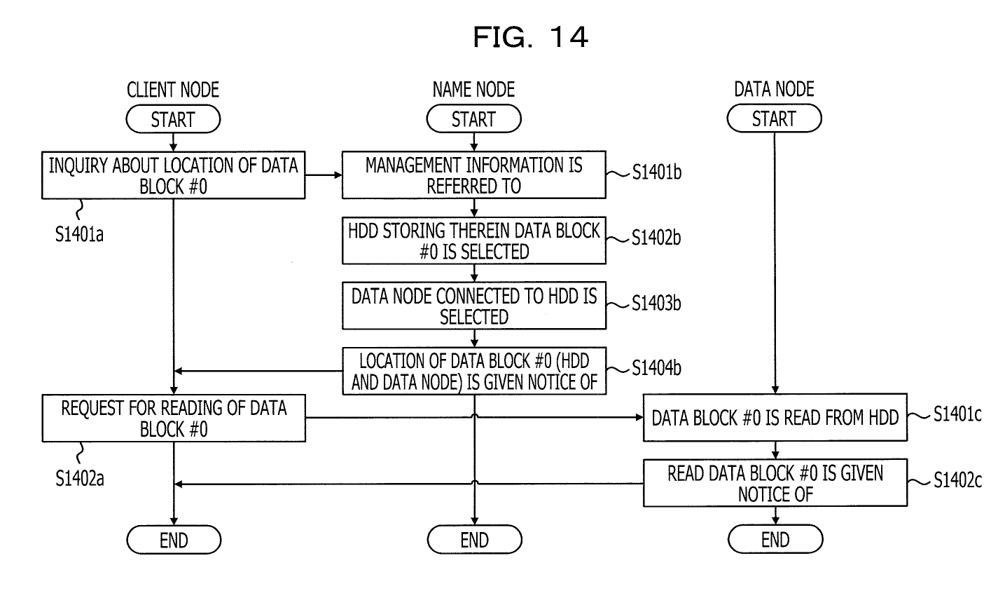

FIG. 14 is a flowchart illustrating an operation flow of the distributed file system 500 when reading a data block. In FIG. 14, a case will be described where the data block #0 is read from the distributed file system 500. However, the case does not have an effect of limiting the processing illustrated in FIG. 14 to the processing for the data block #0.

The client node 550 sends an inquiry to the name node 510 about a location of the data block #0 (S1401a).

Upon receiving the inquiry from the client node 550, the name node 510 refers to the management information 900 (S1401b). The name node 510 selects arbitrary one of HDDs 530 storing therein the data block #0, on the basis of the management information 900 (S1402b). The name node 510 may determine an HDD 530 to be selected, using a round robin method or the like, for example.

The name node 510 selects a data node 520 connected to the HDD 530 selected in S1402b, on the basis of the management information 900 (S1403b). The name node 510 notifies the client node 550 of the location of the data block #0 about which the inquiry has been sent (S1404b). The notification of the location includes the HDD ID of the HDD 530 selected in S1402b and the data node ID of the data node 520 selected in S1403b.

Upon receiving, from the name node 510, the notification of the location of the data block #0, the client node 550 requests the data node 520, specified in the notification of the location of the data block #0, to perform reading of the data block #0 (S1402a). At this time, along with the request for reading the data block #0, the client node 550 specifies the HDD 530 specified in the notification of the location of the data block #0, as the read destination of the data block #0.

Upon receiving the request for reading, the data node 520 reads the data block #0 from the HDD 530 specified by the name node 510 (S1401c). The data node 520 notifies the client node 550 of the read data block #0 (S1402c).

When the above-mentioned processing has been completed, the distributed file system 500 terminates the read processing.

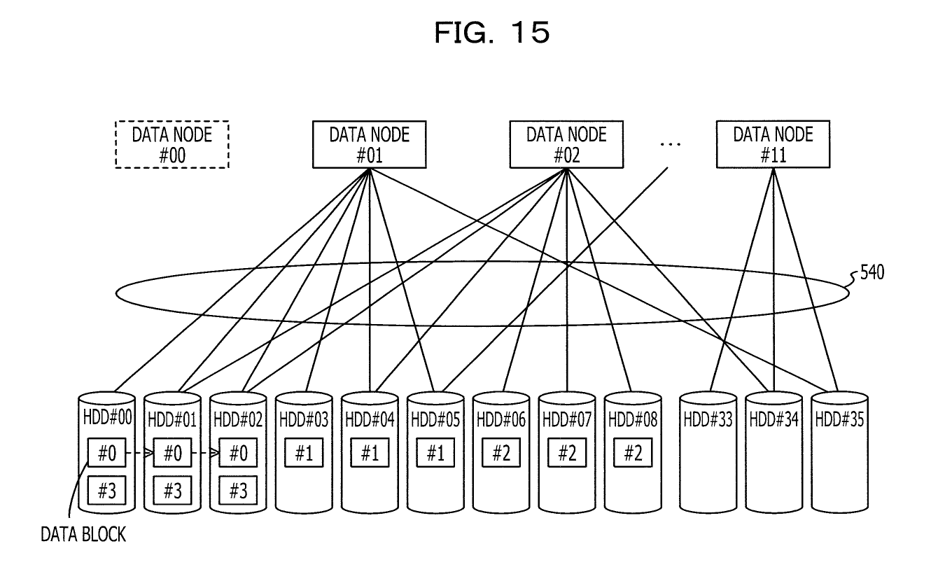

FIG. 15 is a diagram illustrating withdrawal processing for a data node 520.

When one of the data nodes 520 included in the distributed file system 500 has crashed owing to a failure or the like, processing for withdrawing the crashed data node 520 from the distributed file system 500 is performed. FIG. 15 exemplifies a case where the data node #00 has been withdrawn from the distributed file system 500 illustrated in FIG. 10. However, the case does not have an effect of limiting the processing illustrated in FIG. 15 to the processing for the data node #00.

According to an example of the withdrawal processing, as illustrated in FIG. 15, as for the HDDs #00 to #02 and #34 connected to the data node #00 before withdrawal, the HDDs #00 and #02 are handed over to the data node #01, and the HDDs #01 and #34 are handed over to the data node #02.

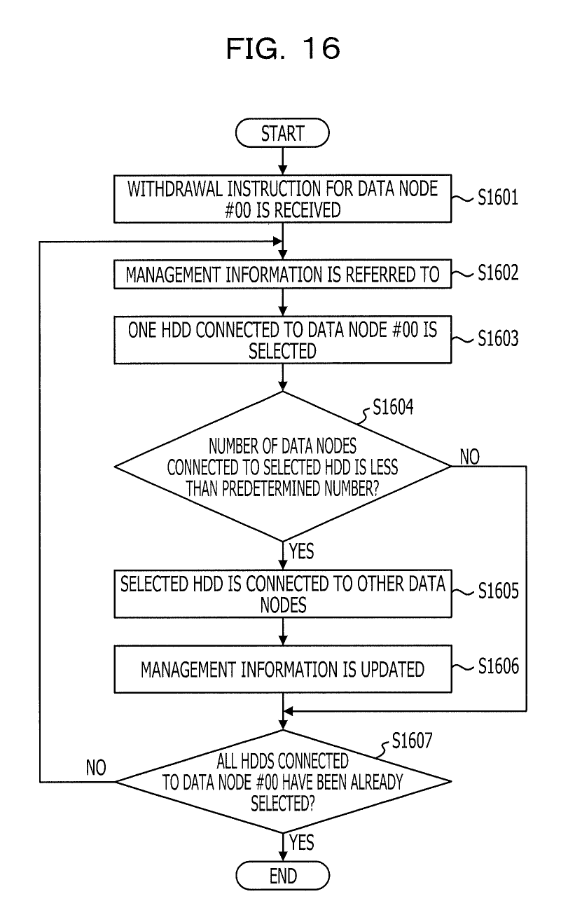

FIG. 16 is a flowchart illustrating an operation flow of withdrawal processing in the distributed file system 500. In the following description, as an example, fail-over processing will be described that is performed when the data node #00 is to be withdrawn. However, the case does not have an effect of limiting the processing illustrated in FIG. 16 to the processing for the data node #00.

The name node 510 receives an instruction for withdrawing the data node #00, which is issued by a predetermined operation of a user (S1601). Upon receiving the instruction, the name node 510 refers to the management information 900 (S1602). The name node 510 selects one HDD 530 connected to the data node #00 (S1603).

When the number of data nodes 520, other than the data node #00, connected to the HDD 530 selected in S1603 is less than a predetermined number (S1604: YES), the name node 510 proceeds the processing to S1605. In this case, the name node 510 selects data nodes 520 as many as the number corresponds to a shortfall with respect to the predetermined number. The data nodes 520 already connected to the HDD selected in S1603 are excluded from the selection.

When having selected the data nodes 520, the name node 510 connects each of the selected data nodes 520 to the HDD 530 selected in S1603 (S1605). So as to connect an HDD 530 and a data node 520 to each other, for example, the zone permission table 800 illustrated in FIG. 8 may be changed. Since the method for setting the zone permission table 800 has been described with reference to FIG. 8, the description thereof will be omitted.

Upon completion of the operation in S1605, the name node 510 reflects a connection relationship, changed in S1605, between the HDD 530 and the name node 510 in the management information 900 (S1606).

When, at least one of the HDDs 530 connected to the data node #00 has not been selected in S1603 (S1607: NO), the name node 510 proceeds the processing to S1602 and repeats the operations in S1602 to S1607.

When all HDDs 530 connected to the data node #00 have been already selected in S1603 (S1607: YES), the name node 510 terminates the withdrawal processing.

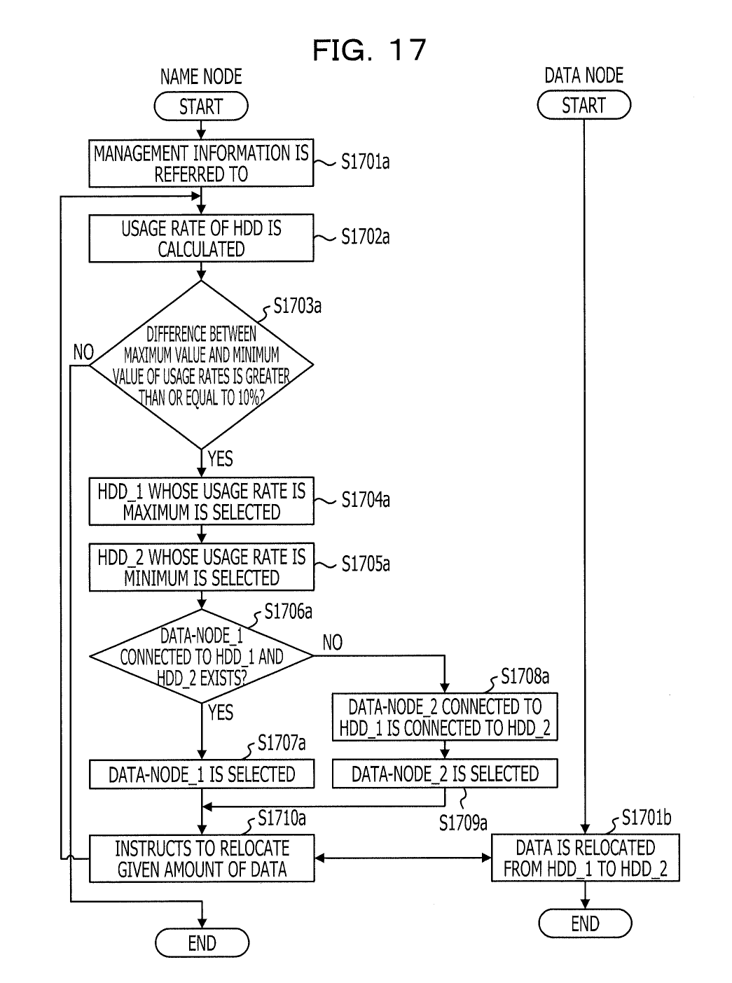

FIG. 17 is a flowchart illustrating an operation flow of rebalancing processing in the distributed file system 500.

Upon receiving an instruction for rebalancing processing, which is issued by a predetermined operation of a user, the name node 510 starts the rebalancing processing. The name node 510 refers to the management information 900 (S1701a), and calculates a usage rate of each HDD 530 registered in the management information 900 (S1702a). While the usage rate of the HDD 530 is used in the present embodiment, it may be possible to use various kinds of information which indicate a load on the HDD 530, such as the free space and the access frequency of the HDD 530.

When a difference between the maximum value and the minimum value of the usage rates is greater than or equal to 10% (S1703a: YES), the name node 510 selects an HDD whose usage rate is the maximum (S1704a). This selected HDD is referred to as an “HDD_1” in the following description. In addition, the name node 510 selects an HDD whose usage rate is the minimum (S1705a). This selected HDD is referred to as an “HDD_2” in the following description.

While it is determined whether or not a difference between the maximum value and the minimum value of the usage rates is greater than or equal to 10% in S1703a, this is just an example and does not have an effect of limiting to 10%.

When a data node 520 exists that is connected to both of the HDD_1 and HDD_2 (S1706a: YES), the name node 510 selects the data node 520 connected to both of the HDD_1 and HDD_2 (S1707a). This selected data node 520 is referred to as a “data-node_1” in the following description.

When no data node 520 exists that is connected to both of the HDD_1 and HDD_2 (51706a: NO), the name node 510 connects a data node 520 connected to the HDD_1 to the HDD_2 (S1708a). The name node 510 selects the data node 520 finally connected to both of the HDD_1 and HDD_2 (S1709a). This selected data node 520 is referred to as a “data-node_2” in the following description.

The name node 510 instructs the data-node_1 selected in S1707a or the data-node_2 selected in S1709a to relocate a given amount of data from the HDD_1 to the HDD_2 (S1710a).

Upon receiving the instruction for data relocation from the name node 510, the data node 520 relocates the given amount of data from the HDD_1 to the HDD_2 (S1701b). The data relocation is performed through the DAS network 540. When the data relocation has been completed, the data node 520 notifies the name node 510 of that effect.

When the data relocation has been completed, the name node 510 proceeds the processing to S1702a. The operations in S1702a to S1710a are repeated. When the difference, calculated in S1702a, between the maximum value and the minimum value of the usage rates of the HDDs has become less than 10% (S1703a: NO), the name node 510 terminates the rebalancing processing.

### Third Embodiment

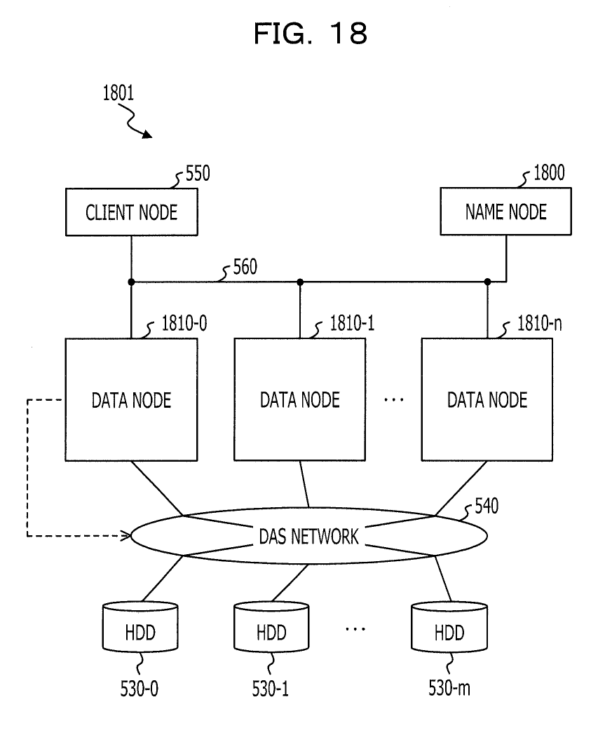

FIG. 18 is a diagram illustrating an example of a configuration of a distributed file system 1801 according to a third embodiment.

The distributed file system 1801 includes a name node 1800, a plurality of data nodes 1810-0, 1810-1, . . . , and 1810-n, a DAS network 540, and a plurality of HDDs 530-0, 530-1, . . . , and 530-m. Hereinafter, one arbitrary data node from among the data nodes 1810-0, 1810-1, . . . , and 1810-n is referred to as a “data node 1810”. More than one arbitrary data nodes from among the data nodes 1810-0, 1810-1, . . . , and 1810-n are referred to as a “data nodes 1810”.

The name node 1800 and the plurality of data nodes 1810-0, 1810-1, . . . , and 1810-n are communicably connected through the network 560. In addition, the plurality of data nodes 1810-0, 1810-1, . . . , and 1810-n and the plurality of HDDs 530-0, 530-1, . . . , and 530-m are communicably connected through the DAS network 540.

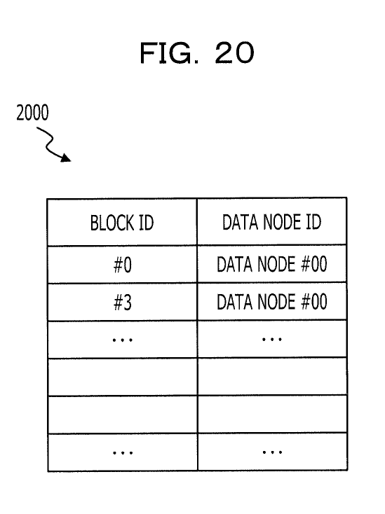

The name node 1800 manages a correspondence relationship between a data block and a data node 1810 storing therein the data block, for each data block. Data block management information 2000 illustrated in FIG. 20 may be used for this management, for example. The data block management information 2000 may include a block ID identifying a data block and a data node ID identifying a data node.

In the present embodiment, a “data node 1810 storing therein a data block”, which is managed by the name node 1800 for each data block, means a data node 1810 connected to a main management HDD storing therein the data block. The main management HDD will be described later.

In response to an inquiry from the client node 550, the name node 1800 selects a plurality of data nodes 1810 into which a data block is to be written, on the basis of the data block management information 2000. The name node 1800 notifies the client node 550 of the selected data nodes 1810.

In response to an inquiry from the client node 550, the name node 1800 notifies the client node 550 of a data node 1810 storing therein a data block, on the basis of the data block management information 2000.

In response to a predetermined operation of a user, the name node 1800 performs rebalancing processing. In this case, the name node 1800 repeats processing in which a data block is relocated from a data node whose usage rate is the maximum to a data node whose usage rate is the minimum until a difference between the maximum value and the minimum value of the usage rates of the data nodes 1810 becomes less than or equal to a given percentage.

In response to a predetermined operation of a user, the name node 1800 performs withdrawal processing for a data node 1810. In the withdrawal processing, for example, the name node 1800 creates a replica of a data block having been stored in a withdrawn data node 1810, in another data node 1810.

Each of the data nodes 1810-0, 1810-2, . . . , and 1810-n is connected to one or more HDDs from among the HDDs 530-0, 530-1, . . . , and 530-m through the DAS network 540.

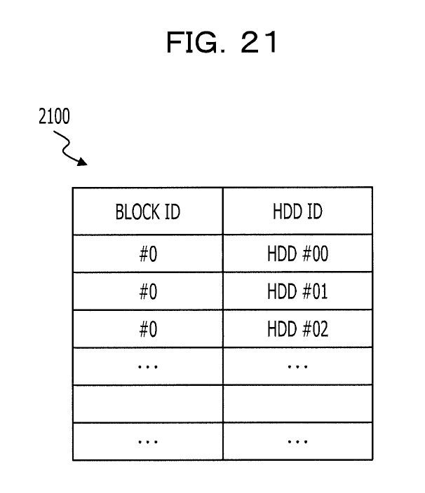

The data node 1810 manages a data block stored in an HDD 530 connected to the data node 1810. For example, data block management information 2100 illustrated in FIG. 21 may be used for this management. The data block management information 2100 may include a block ID identifying a data block and an HDD ID identifying an HDD 530 storing therein the data block identified by the block ID.

The data node 1810 separately manages HDDs 530 connected to the data node 1810 with separating the HDDs 530 into an HDD 530 for which the data node 1810 functions as an interface with the name node 1800 and HDDs 530 for which another data node functions as an interface with the name node 1800. Hereinafter, from among HDDs 530 connected to the data node 1810, an HDD 530 for which the data node 1810 functions as an interface with the name node 1800 is referred to as a “main management HDD”. As the usage rate of the data node 1810, the usage rate of the main management HDD of the data node 1810 is used. In addition, from among the HDDs 530 connected to the data node 1810, an HDD 530 for which another data node functions as an interface with the name node 1800 is referred to as a “sub management HDD”.

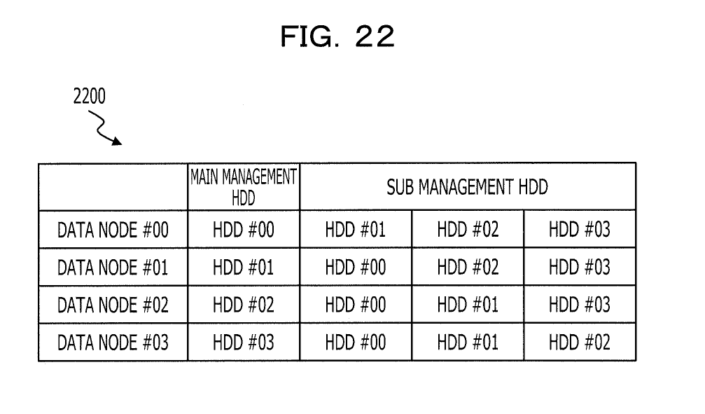

HDD connection management information 2200 illustrated in FIG. 22 may be used for the management of the main management HDD and the sub management HDD. The HDD connection management information 2200 may include, for each data node 1810, an HDD ID identifying the main management HDD and an HDD ID identifying the sub management HDD.

In accordance with an instruction from the name node 1800, the data node 1810 performs data block writing or the data block relocation between connected HDDs 530, through the DAS network 540 or through the network 560.

For example, when data block writing is performed between HDDs 530 connected to the data node 1810 through the DAS network 540, the data node 1810 may perform the data block writing using the DAS network 540. The network 560 is not used for the data block writing between HDDs 530.

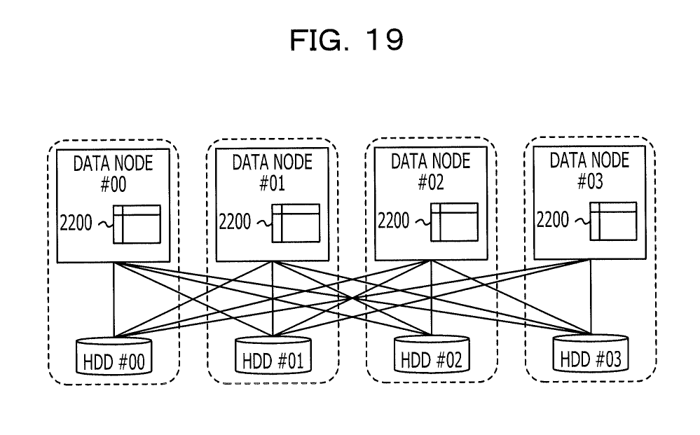

FIG. 19 is a diagram illustrating a connection relationship between the main management HDD and the sub management HDD. While FIG. 19 illustrates an example of a configuration where the number of data nodes 1810 is four and the number of HDDs is four, for ease of explanation, the example does not have an effect of limiting the distributed file system 1801 to the configuration illustrated in FIG. 19.

The data node #00 is connected to the HDD #00 serving as the main management HDD of the data node #00. The data node #00 manages the storage state or the like of a data block stored in the main management HDD #00. The data node #00 periodically transmits, to the name node 1800, the storage state or the like of a data block stored in the main management HDD #00, as a block report. The main management HDD is defined in advance from among HDDs 530 in the distributed file system 1801. In the same way, the data nodes #01 to #03 are connected to the HDDs #01, #02, and #03 serving as main management HDDs of the data nodes #01 to #03, respectively.

In addition, the data node #00 is connected to the HDDs #01, #02, and #03 serving as sub management HDDs of the data node #00, which are managed by data nodes 1810 other than the data node #00. In the same way, the data nodes #01 to #03 are connected to the HDD #00, #02, and #03, the HDDs #00, #01, and #03, the HDDs #00, #01, and #02 serving as sub management HDDs of the data nodes #01 to #03, respectively.

While FIG. 19 illustrates an example where one main management HDD is assigned to each data node 1810, a plurality of main management HDDs may be assigned to one data node 1810.

FIG. 22 is a diagram illustrating an example of the HDD connection management information 2200.

The HDD connection management information 2200 may include the HDD ID of a main management HDD connected to a data node 1810 and the HDD ID of a sub management HDD connected to the data node 1810, for each data node 1810. The HDD connection management information 2200 illustrated in FIG. 22 corresponds to connection relationships of each data node 1810 with the main management HDD and the sub management HDDs illustrated in FIG. 19.

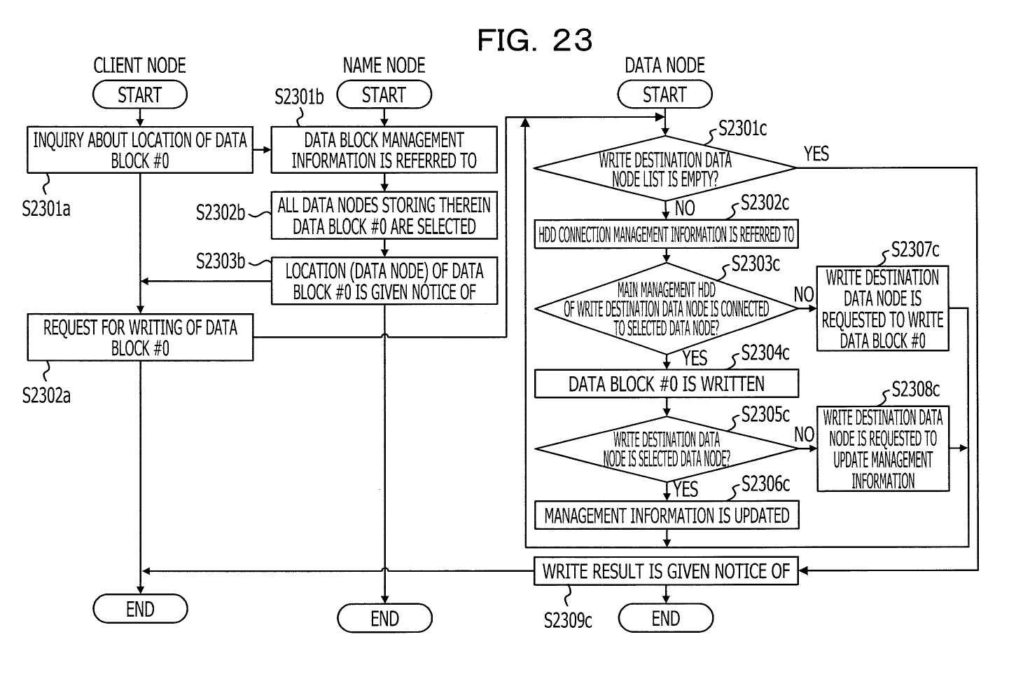

FIG. 23 is a flowchart illustrating an operation flow of the distributed file system 1801 when writing a data block.

The client node 550 divides a file, which is to be written into the distributed file system 1801, into data blocks each of which has a predetermined size. The client node 550 starts write processing for the distributed file system 1801. In FIG. 23, processing will be described that is performed when the data block #0 is written into the distributed file system 1801. However, the case does not have an effect of limiting the processing illustrated in FIG. 23 to the processing for the data block #0.

The client node 550 sends an inquiry to the name node 1800 about a location of the data block #0 (S2301a).

Upon receiving the inquiry from the client node 550, the name node 1800 refers to the data block management information 2000 (S2301b). The name node 1800 selects all data nodes 1810 storing therein the data block #0, on the basis of the data block management information 2000 (S2302b). When the data block #0 about which the inquiry has been sent from the client node 550 is not registered in the data block management information 2000, the name node 1800 selects data nodes 1810 as many as the number corresponds to the preliminarily set number of replicas. The name node 1800 registers the selected data nodes 1810 in the data block management information 2000 in association with the data block #0.

Upon completion of the above-mentioned processing, the name node 1800 notifies the client node 550 of the location of the data block #0 about which the inquiry has been sent (S2303b). The notification of the location includes the data node IDs of the data nodes 1810 selected in S2302b.

Upon receiving, from the name node 1800, the notification of the location of the data block #0, the client node 550 selects one data node 1810 from among the data nodes 1810 specified in the notification of the location of the data block #0. The name node 1800 requests the selected data node 1810 to perform writing of the data block #0 (S2302a). Hereinafter, the selected data node 1810 is referred to as a “selected data node”. Along with the request for writing the data block #0, the client node 550 transmits a list of data node IDs included in the notification of the location of the data block #0, as the write destination of the data block #0. Hereinafter, this list is referred to as a “write destination data node list”.

Upon receiving the request for writing, the selected data node confirms the write destination data node list transmitted from the client node 550. When the write destination data node list is empty (S2301c: YES), the selected data node notifies the client node 550 of a result of writing of the data block #0 (S2309c).

When the write destination data node list is not empty (S2301c: NO), the selected data node determines one data node 1810 on the basis of the write destination data node list. Hereinafter, the determined data node 1810 is referred to as a “write destination data node”.

The selected data node refers to the HDD connection management information 2200 (S2302c), and confirms whether or not the main management HDD of the write destination data node is connected to the selected data node.

When the main management HDD of the write destination data node is connected to the selected data node (S2303c: YES), the selected data node writes the data block into the main management HDD of the write destination data node (S2304c).

When the write destination data node is the selected data node (S2305c: YES), the selected data node updates the data block management information 2100 of the selected data node (S2306c). The selected data node proceeds the processing to S2301c.

When the main management HDD of the write destination data node is not connected to the selected data node (S2303c: NO), the selected data node requests the write destination data node to perform writing of the data block (S2307c). Upon receiving, from the write destination data node, the notification of the completion of the writing of the data block #0, the selected data node proceeds the processing to S2301c.

When the write destination data node is not the selected data node (S2305c: NO), the selected data node requests the write destination data node to update the data block management information 2100 (S2308c). Upon receiving, from the write destination data node, the notification of the completion of the update of the data block management information 2100, the selected data node proceeds the processing to S2301c.

When the operations in S2301c to S2308c have been terminated, the selected data node notifies the client node 550 of a write result (S2309c).

When the above-mentioned processing has been completed, the distributed file system 1801 terminates the write processing.

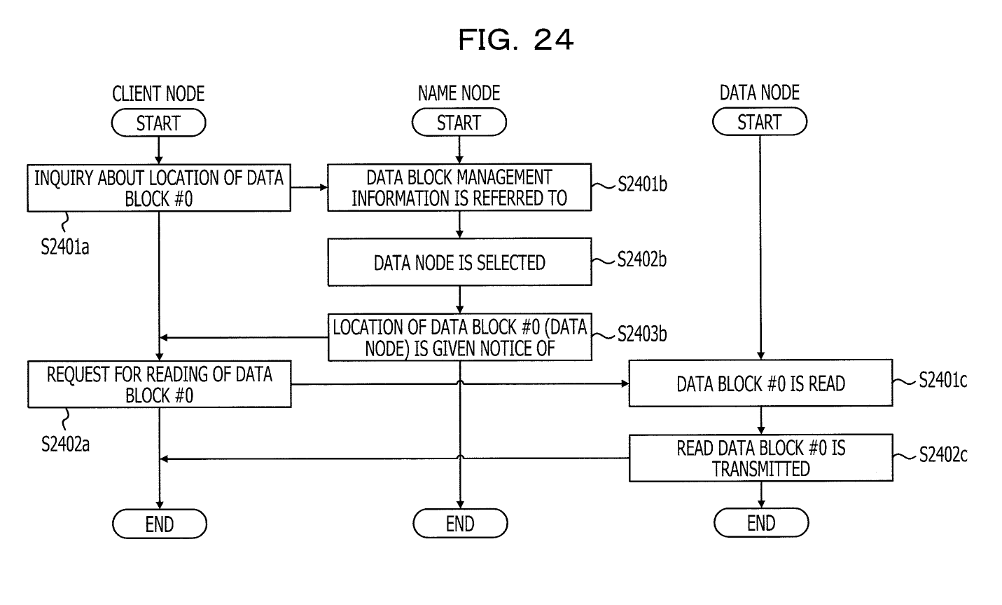

FIG. 24 is a flowchart illustrating an operation flow of the distributed file system 1801 when reading a data block. In FIG. 24, a case will be described where the data block #0 is read from the distributed file system 1801. However, the case does not have an effect of limiting the processing illustrated in FIG. 24 to the processing for the data block #0.

The client node 550 sends an inquiry to the name node 1800 about a location of the data block #0 (S2401a).

Upon receiving the inquiry from the client node 550, the name node 1800 refers to the data block management information 2000 (S2401b). The name node 1800 selects arbitrary one of data nodes 1810 storing therein the data block #0, on the basis of the data block management information 2000 (S2402b). The name node 1800 may determine a data node 1810 to be selected, using the round robin method or the like, for example.

The name node 1800 notifies the client node 550 of the location of the data block #0 about which the inquiry has been sent (S2403b). The notification of the location includes the data node ID of the data node 1810 selected in S2402b.

Upon receiving, from the name node 1800, the notification of the location of the data block #0, the client node 550 requests the data node 1810, specified in the notification of the location of the data block #0, to perform reading of the data block #0 (S2402a).

Upon receiving the request for reading, the data node 1810 reads the data block #0 from the main management HDD connected to the data node 1810 itself (S2401c). The data node 1810 transmits the read data block #0 to the client node 550 (S2402c).

When the above-mentioned processing has been completed, the distributed file system 1801 terminates the read processing.

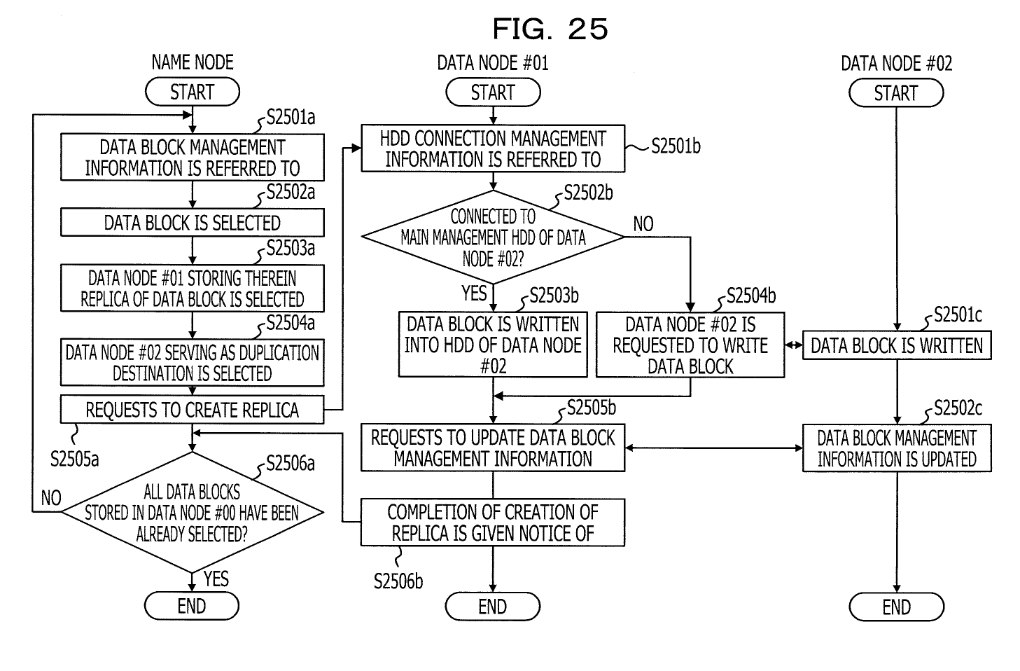

FIG. 25 is a flowchart illustrating an operation flow of withdrawal processing in the distributed file system 1801. In the following description, as an example, fail-over processing will be described that is performed when the data node #00 is to be withdrawn. However, the case does not have an effect of limiting the processing illustrated in FIG. 25 to the processing for the data node #00.

The name node 1800 receives an instruction for withdrawing the data node #00, which is issued by a predetermined operation of a user. Upon receiving the instruction, the name node 1800 starts withdrawal processing for the data node #00. Hereinafter, as an example, a case will be described where the withdrawal instruction for the data node #00 has been received. However, the case does not have an effect of limiting the processing illustrated in FIG. 25 to the processing for the data node #00.

Upon receiving the withdrawal instruction for the data node #00, the name node 1800 refers to the data block management information 2000 (S2501a), and selects one data block stored in the HDD 530 connected to the data node #00 (S2502a).

The name node 1800 selects, from among data nodes 1810 storing therein the replicas of the data block selected in S2502a, an arbitrary data node 1810 as a duplication source of the data block (S2503a). Hereinafter, it is assumed that the data node 1810 selected at this time is the data node #01.

In addition, the name node 1800 selects one arbitrary data node 1810 as a duplication destination of the data block selected in S2502a (S2504a). Hereinafter, it is assumed that the data node 1810 selected at this time is the data node #02. This data node #02 is a data node 1810 other than the data node #01 selected in S2503a. In addition, the data node #02 is connected to the data node #01 selected in S2503a and an HDD 530.

When having selected the data nodes #01 and #02, the name node 1800 requests the data node #01 to create a replica (S2505a).

Upon receiving, from the name node 1800, the request for the creation of a replica, the data node #01 refers to the HDD connection management information 2200 of the data node #01 to confirm whether or not the data node #01 is connected to the main management HDD of the data node #02 (S2501b).

When the data node #01 is connected to the main management HDD of the data node #02 (S2502b: YES), the data node #01 writes the data block into the main management HDD of the data node #02 (S2503b). The writing of the data block into the main management HDD of the data node #02 may be performed through the DAS network 540 without using the network 560.

When the data node #01 is not connected to the main management HDD of the data node #02 (S2502b: NO), the data node #01 requests the data node #02 to perform writing of the data block (52504b). Upon receiving, from the data node #01, the request for writing the data block, the data node #02 writes the data block into the main management HDD of the data node #02 (S2501c). The data node #02 notifies the data node #01 of the completion of the writing of the data block.

When the creation of the replica of the data block has been completed in S2503b or S2504b, the data node #01 requests the data node #02 to update the data block management information 2100 of the data node #02 (S2505b). Upon receiving the request for the update of the data block management information 2100, the data node #02 updates the data block management information 2100 of the data node #02 (S2502c). The data node #02 notifies the data node #01 of the completion of the update of the data block management information 2100.

When the operations in S2501b to S2505b have been completed, the data node #01 notifies the name node 1800 of the completion of the creation of the replica of the data block (S2506b).

Upon receiving, from the data node #01, the notification of the completion of the creation of the replica of the data block, the name node 1800 confirms whether or not all data blocks stored in the data node #00 have been selected.

When a data block that has not been selected exists in the data node #00 (S2506a: NO), the name node 1800 proceeds the processing to S2501a. The name node 1800 repeats the operations in S2501a to S2506a. When all data blocks stored in the data node #00 have been selected (S2506a: YES), the name node 1800 terminates the processing.

When the above-mentioned processing has been completed, the distributed file system 1801 terminates the withdrawal processing.

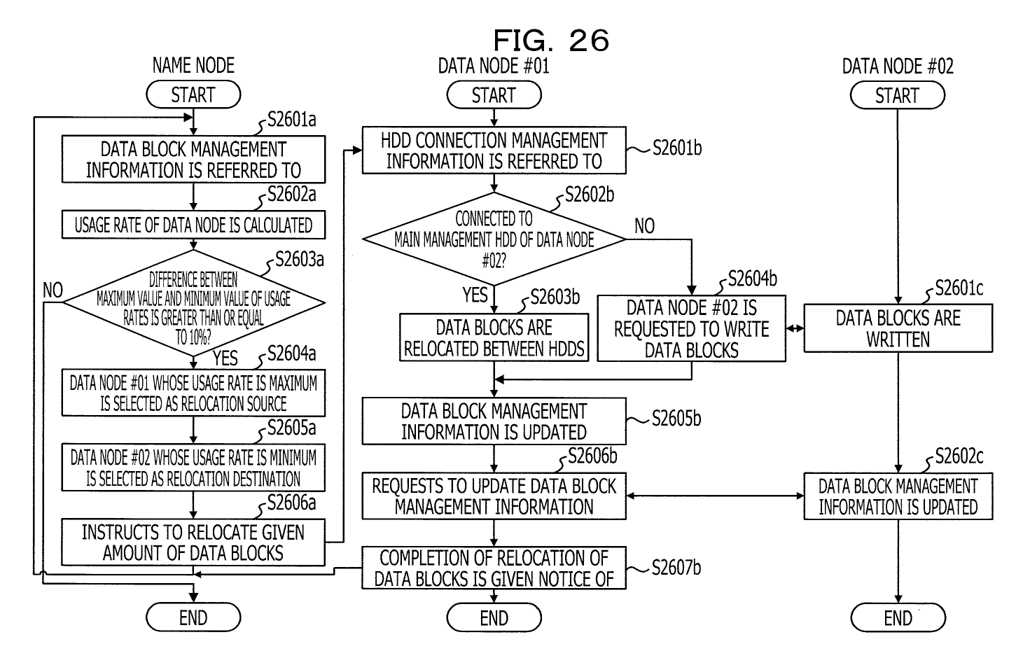

FIG. 26 is a flowchart illustrating an operation flow of rebalancing processing in the distributed file system 1801.

Upon receiving an instruction for the rebalancing processing, which is issued by a predetermined operation of a user, the name node 1800 refers to the data block management information 2000 (S2601a), and calculates a usage rate of each data node, namely, a usage rate of the main management HDD connected to each data node 1810 (S2602a). While the usage rate of the main management HDD is used in the present embodiment, it may be possible to use various kinds of information which indicate a load on the main management HDD, such as the free space and the access frequency of the main management HDD.

When a difference between the maximum value and the minimum value of the usage rates is greater than or equal to 10% (S2603a: YES), the name node 1800 selects a data node whose usage rate is the maximum, as the relocation source of a data block (S2604a). Hereinafter, it is assumed that this selected data node is the data node #01.

In addition, the name node 1800 selects a data node whose usage rate is the minimum, as the relocation destination of the data block (S2605a). Hereinafter, it is assumed that this selected data node is the data node #02.

When having selected the relocation source and relocation destination of the data block, the name node 1800 instructs the data node #01 serving as the relocation source to relocate a given amount of data blocks, with specifying the data node #02 as the relocation destination (S2606a).

Upon receiving, from the name node 1800, the instruction for the data block relocation, the data node #01 refers to the HDD connection management information 2200 (S2601b). The data node #01 confirms whether or not the data node #01 and the main management HDD of the data node #02 serving as the relocation destination of the data block are connected to each other.

When the data node #01 and the main management HDD of the data node #02 are connected to each other (S2602b: YES), the data node #01 proceeds the processing to S2603b. In this case, the data node #01 relocates a given amount of data blocks from the main management HDD of the data node #01 to the main management HDD of the data node #02 (52603b). The data block relocation at this time may be performed through the DAS network 540 without using the network 560.

When the data node #01 and the main management HDD of the data node #02 are not connected to each other (S2602b: NO), the data node #01 requests the data node #02 to perform writing of the data blocks (S2604b). At this time, the data node #01 reads a given amount of data blocks from the main management HDD of the data node #01 and transmits the given amount of data blocks to the data node #02. Upon receiving, from the data node #01, the request for writing the data blocks, the data node #02 writes the received data blocks into the main management HDD of the data node #02 (S2601c). The data node #02 notifies the data node #01 of the completion of the writing of the data blocks.

When the data block relocation has completed through the operation in S2603b or S2604b, the data node #01 updates the data block management information 2100 of the data node #01 (S2605b). In addition, the data node #01 requests the data node #02 serving as the relocation destination of the data blocks to update the data block management information 2100 of the data node #02 (S2606b). Upon receiving the request for updating the data block management information 2100, the data node #02 updates the data block management information 2100 of the data node #02 (S2602c). The data node #02 notifies the data node #01 of the completion of the update of the data block management information 2100.

When the operations in S2601b to S2606b have been completed, the data node #01 notifies the name node 1800 of the completion of the data block relocation (S2607b).

Upon receiving, from the data node #01, the completion of the data block relocation, the name node 1800 proceeds the processing to S2601a. The name node 1800 repeats the operations in S2601a to S2606a.

When the above-mentioned processing has been completed, the distributed file system 1801 terminates the rebalancing processing.

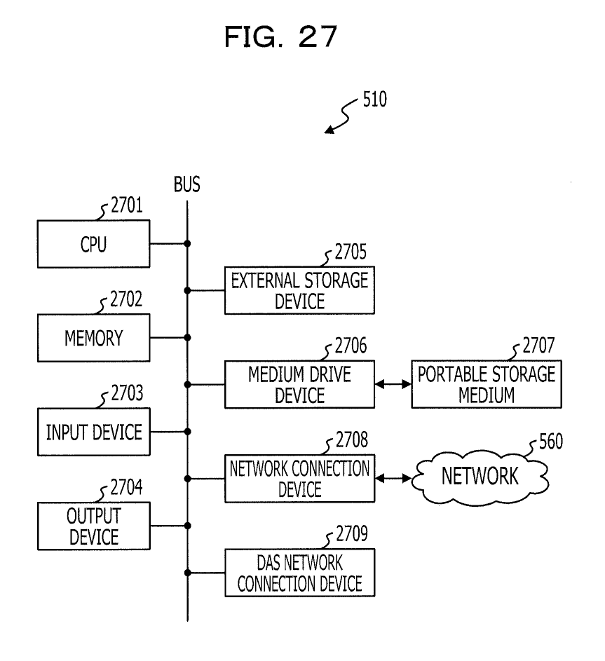

FIG. 27 is a diagram illustrating an example of a specific configuration of the name node 510.

The name node 510 illustrated in FIG. 27 includes a central processing unit (CPU) 2701, a memory 2702, an input device 2703, an output device 2704, an external storage device 2705, a medium drive device 2706, a network connection device 2708, and a DAS network connection device 2709. These devices are connected to a bus to send and receive data with one another.

The CPU 2701 is an arithmetic device executing a program used for realizing the distributed file system 500 according to the present embodiment, in addition to executing peripheral devices and various kinds of software.

The memory 2702 is a volatile storage device used for executing the program. For example, a random access memory (RAM) or the like may be used as the memory 2702.

The input device 2703 is a device to input data from the outside. For example, a keyboard, a mouse, or the like may be used as the input device 2703. The output device 2704 is a device to output data or the like to a display device or the like. In addition, the output device 2704 may also include a display device.

The external storage device 2705 is a non-volatile storage device storing therein the program used for realizing the distributed file system 500 according to the present embodiment, in addition to a program and data desirable for causing the name node 510 to operate. For example, a magnetic disk storage device or the like may be used as the external storage device 2705.

The medium drive device 2706 is a device to output data in the memory 2702 or the external storage device 2705 to a portable storage medium 2707, for example, a flexible disk, a magneto-optic (MO) disk, a compact disc recordable (CD-R), a digital versatile disc recordable (DVD-R), or the like and to read a program, data, and the like from the portable storage medium 2707.

The network connection device 2708 is an interface connected to the network 560. The DAS network connection device 2709 is an interface connected to the DAS network 540, for example, the SAS expander 600.

In addition, a non-transitory medium may be used as a storage medium such as the memory 2702, the external storage device 2705, and the portable storage medium 2707, which is readable by information processing apparatuses. FIG. 27 is an example of the configuration of the name node 510. In other words, the example does not have an effect of limiting the configuration of the name node 510 to the configuration illustrated in FIG. 27. As for the configuration of the name node 510, a portion of the configuration elements illustrated in FIG. 27 may be omitted if desired, and a configuration element not illustrated in FIG. 27 may be added.

While an example of the configuration of the name node 510 according to the present embodiment has been described with reference to FIG. 27, the data node 520, the name node 1800, and the data node 1810 may also include the same configuration as that in FIG. 27. However, it should be understood that data node 520, the name node 1800, and the data node 1810 are not limited to the configuration illustrated in FIG. 27.

In the above-mentioned description, the HDD 530 is an example of a storage device. The client node 550 is an example of a first node. The data node 520 or the data node 1810 is an example of a second node. The DAS network 540 is an example of a relay network. The name node 510 or the name node 1800 is an example of a third node.

As described above, the data node 520 is connected to the HDD 530 through the DAS network 540. In the processing for writing a data block into the distributed file system 500, the data node 520 performs the writing of the data block on all HDDs 530 included in the write destination HDD list received from the client node 550. The writing the data block into the HDDs 530 is performed through the DAS network 540 without using the network 560. Therefore, the traffic of the network 560 at the time of writing the data block into the distributed file system 500 may be kept low. As a result, it may be possible to enhance the speed of writing from the client node 550 into the distributed file system 500.

The data node 1810 is also connected to the HDD 530 through the DAS network 540. In the processing for writing a data block into the distributed file system 1801, when the main management HDD serving as the write destination data node is connected to the selected data node, the selected data node writes the data block into the main management HDD of the write destination data node. The writing the data block into the main management HDD is performed through the DAS network 540 without using the network 560. Therefore, the traffic of the network 560 at the time of writing the data block into the distributed file system 1801 may be kept low. As a result, it may be possible to enhance the speed of writing from the client node 550 into the distributed file system 1801.

The distributed file systems 500 and 1801 write data blocks into the HDDs 530 through the DAS network 540. Accordingly, for example, the priority of processing for creating a replica when the data block is written into the HDD 530 may not be decreased so as to suppress traffic occurring in the network 560.

In the withdrawal processing in the distributed file system 500, the name node 510 connects a data node 520 other than the data node #00 to be withdrawn and an HDD 530 connected to the data node #00, to each other. The data node 520 is connected to an HDD 530 connected to the data node #00. Accordingly, without duplicating, on another data node, the replica of a data block stored in the HDD 530 connected to the data node #00 to be withdrawn, the restoration or relocation of the replica may be performed at a fast rate. Since the replica is not duplicated on another data node, traffic due to the withdrawal processing does not occur in the network 560. As a result, it may be possible to improve the speed of access to the distributed file system 500 at the time of the withdrawal processing.

In the withdrawal processing in the distributed file system 1801, when the data node #01 serving as the duplication source of a data block is connected to the main management HDD of the data node #02 serving as the duplication destination of the data block, the data node #01 writes the data block into the main management HDD of the data node #02. The writing of the data block is performed through the DAS network 540 without using the network 560. Therefore, at the time of the withdrawal processing in the distributed file system 1801, it may be possible to avoid a large amount of network communication from occurring in the network 560. As a result, it may be possible to improve the speed of access to the distributed file system 1801 at the time of the withdrawal processing. In addition, it may also be possible to perform the withdrawal processing at a fast rate.

In the distributed file system 500, since it may also be possible to perform the restoration or relocation of a replica at a fast rate when a data node 520 crashes, the number of replicas may not be increased so as to maintain the redundancy of the distributed file system 500 when the data node 520 crashes. Since the number of replicas may not be increased, a decrease in a data storage capacity may not occur in association with an increase in the number of replicas. The same as in the distributed file system 500 applies to the distributed file system 1801.

In the rebalancing processing in the distributed file system 500, the name node 510 instructs a data node 520, which is connected through the DAS network 540 to both of the HDD_1 whose usage rate is the maximum and the HDD_2 whose usage rate is the minimum, to perform data relocation. This data relocation is performed through the DAS network 540 without using the network 560. Therefore, at the time of the rebalancing processing in the distributed file system 500, it may be possible to avoid a large amount of network communication from occurring in the network 560. As a result, it may be possible to improve the speed of access to the distributed file system 500 at the time of the rebalancing processing. In addition, it may also be possible to perform the rebalancing processing at a fast rate.

In the rebalancing processing in the distributed file system 1801, when the data node #01 and the main management HDD of the data node #02 are connected to each other, the data node #01 relocates a data block from the main management HDD of the data node #01 to the main management HDD of the data node #02. The data node #01 is the relocation source of the data block. The data node #02 is the relocation destination of the data block. The data block relocation is performed through the DAS network 540 without using the network 560. Therefore, at the time of the rebalancing processing in the distributed file system 1801, it may be possible to avoid a large amount of network communication from occurring in the network 560. As a result, it may be possible to improve the speed of access to the distributed file system 1801 at the time of the rebalancing processing. In addition, it may also be possible to perform the rebalancing processing at a fast rate.

Since a data node 520 is connected to an HDD 530 through the DAS network 540, it may be possible to easily increase the number of data nodes 520 to be connected to the HDD 530. Therefore, it may be possible to cause the number of data nodes 520 able to access to a data block stored in the HDD 530 to be greater than or equal to the number of replicas. As a result, it may be possible for the distributed file system 500 to distribute accesses from the client node 550 to data nodes 520. On the basis of the same reason, it may also be possible for the distributed file system 1801 to distribute accesses from the client node 550 to data nodes 1810.

Since it may be possible for the distributed file system 500 to distribute accesses from the client node 550 to data nodes 520, the number of data blocks does not need to be increased by reducing the size of the data block so as to distribute accesses to the data nodes 520. Since the number of data blocks does not need to be increased by reducing the size of the data block, a load on the processing of the name node 510 managing the location of a data block may not be increased. The same as in the distributed file system 500 applies to the distributed file system 1801.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A file system comprising:
a plurality of storage devices to store therein data transmitted from a first node;
a plurality of second nodes connected to the first node through a first network;
a second network to connect each of the plurality of second nodes with at least one of the plurality of storage devices, the second network being different from the first network; and
a third node to
manage a location of data, and
notify, in response to an inquiry from the first node, the first node of a location of data specified by the first node,
wherein
each of the plurality of second nodes writes, through the second network, same data into a predetermined number of storage devices from among the plurality of storage devices in response to an instruction from the first node.

2. The file system according to claim 1, wherein
the third node
manages a location of data stored in the plurality of storage devices on the basis of management information associating first storage devices storing therein same data and a second node connected to the first storage devices,
selects, as write destinations of data specified by the first node, the predetermined number of storage devices,
selects a second node connected to all of the write destinations, and
notifies the first node of the write destinations and the selected second node.

3. The file system according to claim 1, wherein
the third node
manages a location of data stored in the plurality of storage devices on the basis of management information associating first storage devices storing therein same data and a second node connected to the first storage devices, and
connects, through the second network, a second storage device connected to a second node to be withdrawn with a second node other than the second node to be withdrawn.

4. The file system according to claim 1, wherein
the third node
manages a location of data stored in the plurality of storage devices on the basis of management information associating first storage devices storing therein same data and a second node connected to the first storage devices, and
instructs a common second node to relocate a given amount of data from a primary storage device to a secondary storage device, the primary storage device having a maximum usage rate among the plurality of storage devices, the secondary storage device having a minimum usage rate among the plurality of storage devices, the common second node being connected to both the primary storage device and the secondary storage device through the second network.

5. The file system according to claim 1, wherein
the third node
manages a location of data stored in the plurality of storage devices on the basis of management information associating first storage devices storing therein same data and a second node connected to the first storage devices, and
connects, in absence of a common second node, one second node connected to a primary storage device with a secondary storage device through the second network and instructs the one second node to relocate a given amount of data from the primary storage device to the secondary storage device, the primary storage device having a maximum usage rate among the plurality of storage devices, the secondary storage device having a minimum usage rate among the plurality of storage devices, the common second node being connected to both the primary storage device and the secondary storage device through the second network.

6. The file system according to claim 4, wherein
the third node instructs the common second node to relocate data until a difference between a maximum value and a minimum value of usage rates of the plurality of storage devices falls within a given range.

7. The file system according to claim 5, wherein
the third node instructs the one second node to relocate data until a difference between a maximum value and a minimum value of usage rates of the plurality of storage devices falls within a given range.

8. The file system according to claim 1, wherein
the third node
manages a location of data stored in the plurality of storage devices on the basis of management information associating first storage devices storing therein same data and a second node connected to the first storage devices,
selects, as a read destination of data specified by the first node, a second node connected to a storage device storing therein the specified data, and
notifies the first node of the read destination.

9. The file system according to claim 1, wherein
each second node is connected through the second network to a main management storage device for which each second node functions as an interface to the third node, and
when the first node instructs a representative second node to write specified data, the representative second node writes the specified data into a main management storage device of the representative second node and writes the specified data through the second network into a main management storage device of another second node specified as a write destination by the first node.

10. The file system according to claim 1, wherein
each second node is connected through the second network to a main management storage device for which each second node functions as an interface to the third node, and
when the third node instructs a source second node to duplicate specified data, the source second node writes, through the second network, the specified data stored in a main management storage device of the source second node into a main management storage device of another second node specified as a duplication destination by the third node.

11. The file system according to claim 1, wherein
each second node is connected through the second network to a main management storage device for which each second node functions as an interface to the third node, and
when the third node instructs a source second node to relocate specified data, the source second node relocates, through the second network, the specified data stored in a main management storage device of the source second node into a main management storage device of another second node specified as a relocation destination by the third node.

12. A method for controlling a file system connected to a first node through a first network, the file system including a plurality of storage devices, a second node, and a third node, the method comprising:
notifying, by the third node in response to an inquiry from the first node, the first node of a location of data specified by the first node; and
writing, by the second node, same data into a predetermined number of storage devices from among the plurality of storage devices through a second network different from the first network in response to an instruction from the first node.
